(19) United States
(12) Patent Application Publication
(10) Pub. No.: US 2026/0247142 A1
(43) Pub. Date: Aug. 20, 2026

(54) METHODS AND APPARATUSES FOR SECRET KEY GENERATION

(71) Applicant: LENOVO (BEIJING) LIMITED, Beijing (CN)

(72) Inventors: Wei Chen, Beijing (CN); Haiming Hui, Beijing (CN); Xin Guo, Beijing (CN); Haiming Wang, Beijing (CN)

(21) Appl. No.: 19/159,469

(22) PCT Filed: Feb. 24, 2023
(86) PCT No.: PCT/CN2023/078108

§ 371 Date: Aug. 25, 2025

(51) Int. Cl. H04W 12/041; H04L 9/00

(52) U.S. Cl. CPC H04W 12/041; H04L 9/001; H04L 2209/80

(57) ABSTRACT

Embodiments of the present disclosure relate to methods and apparatuses for secret key generation. According to an embodiment of the present disclosure, a user equipment can include: a transceiver; and a processor coupled to the transceiver and configured to: obtain first configuration information for generating a secret key, wherein the first configuration information indicates a quantization scheme; and generate the secret key based on the first configuration information.

### TECHNICAL FIELD

Embodiments of the present application are related to wireless communication technologies, and more particularly, related to methods and apparatuses for secret key generation.

### BACKGROUND

In a scenario of distributed learning, to learn a global statistical model at a center server, each remote device (e.g., user equipment (UE)) may train its own data locally, and transmit updates (e.g., gradients of the model) to the center server such that the center server may generate the global statistical model based on the updates periodically. To address the privacy concerns, the transmission between each remote device and the center server should be secret so as to avoid eavesdropping from other devices in the system as well as other malicious users. Thus, an independent secret key for the transmission between each remote device and the center server needs to be generated.

### SUMMARY OF THE APPLICATION

Embodiments of the present application at least provide a technical solution for secret key generation.

According to some embodiments of the present application, a UE may include: a transceiver; and a processor coupled to the transceiver and configured to: obtain first configuration information for generating a secret key, wherein the first configuration information indicates a quantization scheme; and generate the secret key based on the first configuration information.

In some embodiments of the present application, the processor is further configured to obtain second configuration information indicating a set of quantization intervals.

In some embodiments of the present application, the second configuration information further indicates mapping relationship between the set of quantization intervals and a set of code words.

In some embodiments of the present application, the set of quantization intervals is divided such that channel measurement values fall within each quantization interval with equal probabilities; or all quantization intervals in the set of quantization intervals have equal lengths except for the last quantization interval in the set of quantization intervals.

In some embodiments of the present application, the first configuration information indicates that a single channel measurement value is used for generating the secret key.

In some embodiments of the present application, the processor is further configured to: determine the single channel measurement value which has a maximum distance relative to a closer endpoint of a quantization interval within which the single channel measurement value falls; and determine the secret key based on a code word corresponding to the quantization interval within which the single channel measurement value falls.

In some embodiments of the present application, the first configuration information indicates index(es) of one or more channel measurements whose channel measurement values are used for generating the secret key.

In some embodiments of the present application, the processor is further configured to: determine the secret key based on one or more code words, wherein each of the one or more code words corresponds to a quantization interval within which a channel measurement value of a channel measurement of the one or more channel measurements falls.

In some embodiments of the present application, the first configuration information indicates that m1 channel measurement values are used for generating the secret key, wherein 1≤m1≤m, and m is a number of channel measurement values obtained by the UE.

In some embodiments of the present application, the processor is further configured to: determine m1 channel measurement values from m channel measurement values obtained by the UE, wherein the m1 channel measurement values have the greatest m1 distances, each of which is relative to a closer endpoint of a quantization interval within which a channel measurement value of the m1 channel measurement values falls; and determine the secret key based on m1 code words, wherein each of the m1 code words corresponds to a quantization interval within which a channel measurement value of the m1 channel measurement values falls.

In some embodiments of the present application, the first configuration information indicates one or more ratio values, and each ratio value is associated with at least one quantization interval.

In some embodiments of the present application, the processor is further configured to: determine m2 channel measurement values from a set of channel measurement values obtained by the UE, wherein a distance from each channel measurement value of the m2 channel measurement values to a closer endpoint of a quantization interval within which the channel measurement value falls is greater than a length of the quantization interval multiplying an associated radio value indicated by the first configuration information; and determine the secret key based on m2 code words, wherein each of the m2 code words corresponds to a quantization interval within which a channel measurement value of the m2 channel measurement values falls.

In some embodiments of the present application, the first configuration information indicates a length of the secret key.

According to some embodiments of the present application, a base station (BS) may include: a transceiver; and a processor coupled to the transceiver and configured to: transmit, via the transceiver, first configuration information for generating a secret key, wherein the first configuration information indicates a quantization scheme to a UE; and generate the secret key based on the first configuration information.

In some embodiments of the present application, the processor is further configured to transmit, via the transceiver, second configuration information indicating a set of quantization intervals.

In some embodiments of the present application, the second configuration information further indicates mapping relationship between the set of quantization intervals and a set of code words.

In some embodiments of the present application, the set of quantization intervals is divided such that channel measurement values fall within each quantization interval with equal probabilities; or all quantization intervals in the set of quantization intervals have equal lengths except for the last quantization interval in the set of quantization intervals.

In some embodiments of the present application, the first configuration information indicates that a single channel measurement value is used for generating the secret key.

In some embodiments of the present application, the processor is further configured to: determine the single channel measurement value which has a maximum distance relative to a closer endpoint of a quantization interval within which the single channel measurement value falls; and determine the secret key based on a code word corresponding to the quantization interval within which the single channel measurement value falls.

In some embodiments of the present application, the first configuration information indicates index(es) of one or more channel measurements whose channel measurement values are used for generating the secret key.

In some embodiments of the present application, the processor is further configured to: determine the secret key based on one or more code words, wherein each of the one or more code words corresponds to a quantization interval within which a channel measurement value of a channel measurement of the one or more channel measurements falls.

In some embodiments of the present application, the first configuration information indicates that m1 channel measurement values are used for generating the secret key, wherein 1≤m1≤m, and m is a number of channel measurement values obtained by the UE.

In some embodiments of the present application, the processor is further configured to: determine m1 channel measurement values from m channel measurement values obtained by the BS, wherein the m1 channel measurement values have the greatest m1 distances, each of which is relative to a closer endpoint of a quantization interval within which a channel measurement value of the m1 channel measurement values falls; and determine the secret key based on m1 code words, wherein each of the m1 code words corresponds to a quantization interval within which a channel measurement value of the m1 channel measurement values falls.

In some embodiments of the present application, the first configuration information indicates one or more ratio values, and each ratio value is associated with at least one quantization interval.

In some embodiments of the present application, the processor is further configured to: determine m2 channel measurement values from a set of channel measurement values obtained by the BS, wherein a distance from each channel measurement value of the m2 channel measurement values to a closer endpoint of a quantization interval within which the channel measurement value falls is greater than a length of the quantization interval multiplying an associated radio value indicated by the first configuration information; and determine the secret key based on m2 code words, wherein each of the m2 code words corresponds to a quantization interval within which a channel measurement value of the m2 channel measurement values falls.

In some embodiments of the present application, the first configuration information indicates a length of the secret key.

In some embodiments of the present application, the processor is configured to transmit, via the transceiver, the first configuration information or the second configuration information via at least one of: a master information block (MIB) message, a system information block (SIB) message, a radio resource control (RRC) signaling, a medium access control (MAC) control element (CE), or downlink control information (DCI).

According to some embodiments of the present application, a method performed by a UE may include: obtaining first configuration information for generating a secret key, wherein the first configuration information indicates a quantization scheme; and generating the secret key based on the first configuration information.

According to some embodiments of the present application, a method performed by a BS may include: transmitting first configuration information for generating a secret key, wherein the first configuration information indicates a quantization scheme to a UE; and generating the secret key based on the first configuration information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates a flowchart of an exemplary method for generating a secret key according to some embodiments of the present application;

FIG. 3 illustrates a flowchart of an exemplary method for generating a secret key according to some other embodiments of the present application; and

FIG. 4 illustrates a simplified block diagram of an exemplary apparatus for generating a secret key according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) long term evolution (LTE) and LTE advanced, 3GPP fifth generation (5G) new radio (NR), 5G-Advanced, sixth generation (6G), and so on. It is contemplated that along with developments of network architectures and new service scenarios, all embodiments in the present application are also applicable to similar technical problems; and moreover, the terminologies recited in the present application may change, which should not affect the principle of the present application.

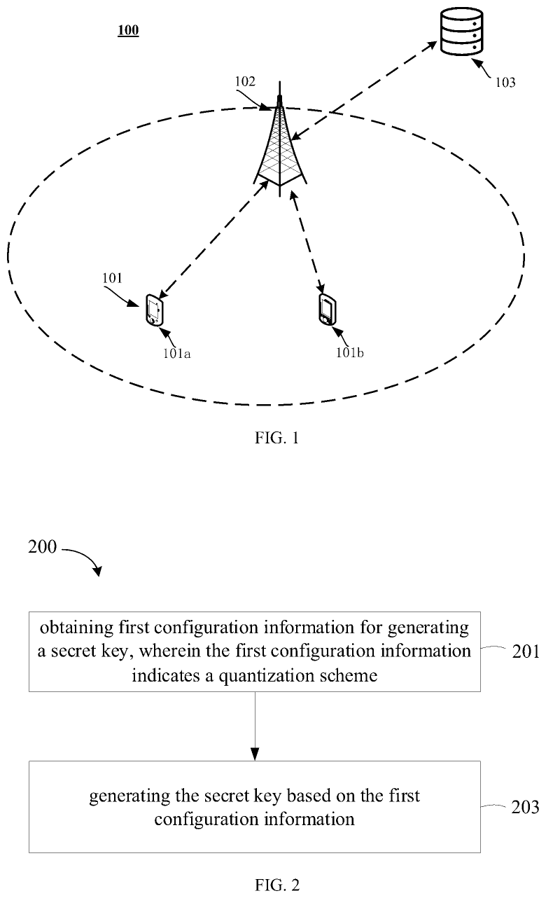

FIG. 1 illustrates an exemplary wireless communication system 100 in accordance with some embodiments of the present application.

As shown in FIG. 1, the wireless communication system 100 includes at least one UE 101, at least one BS 102, and at least one server 103. In particular, the wireless communication system 100 includes two UEs 101 (e.g., UE 101a and UE 101b), one BS 102, and one server 103 for illustrative purpose. Although a specific number of UEs 101, BS 102, and sever 103 are depicted in FIG. 1, it is contemplated that any number of UEs 101, BSs 102, and server 103 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 101a and UE 101b in the example illustrated in FIG. 1 may transmit information to BS 102 and receive information from BS 102, for example, via LTE or NR Uu interface. BS 102 may be distributed over a geographic region. In certain embodiments of the present disclosure, BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. BS 102 is generally a part of a radio access network that may include one or more controllers communicably coupled to BS 102.

The server 103 may be an edge data network (EDN) server, a content server, a cloud server, or any other server which can determine (or learn) a global statistical model. In some embodiments of the present application, the server 103 may also be referred to as a center server. In the example illustrated in FIG. 1, the server 103 is separated from the BS 102. The server 103 may be connected to the BS 102 via a core network (not shown in FIG. 1), via a wired connection manner, via a wireless connection manner, or any other connection manners. In some other embodiments, the sever 103 may be integrated into the BS 102. In this case, the server 103 may be connected to the BS 102 directly, other than via the core network.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

In a scenario of distributed learning, multiple remote devices (e.g., UEs) have their own privacy-concerned data set. In some embodiments, a remote device may also be referred to as a distributed node. To learn a global statistical model at the center server, each remote device may train its own data locally, and then transmit updates (e.g., gradients of the model) to a BS. Then, the BS may transmit the updates from each remote device to the center server (which is either separated from the BS or integrated into the BS) such that the center server may generate the global statistical model based on the updates periodically. To address the privacy concerns, the transmission between each remote device and the BS should be secret so as to avoid eavesdropping from other devices in the system as well as other malicious users. Thus, a specific secret key for the transmission between each remote device and the BS needs to be generated.

One conventional mechanism to generate a shared secret key between two parties is the Diffie-Hellman (D-H) key exchange protocol. However, the computation overhead of the D-H key exchange protocol is significant due to expensive exponential operations. In addition, with the ever-increasing computing power of attackers, the D-H key exchange protocol has to increase the length of the secret key to maintain a certain level of security strength, which in turn aggravates the computation overhead.

According to some embodiments of the present application, a method for generating a secret key based on wireless channel measurements is proposed. Generating a secret key based on wireless channel measurements may have the following advantages:
Solving key management problem, which includes distribution, sharing, and storing of secret keys associated with complexity-based security methods.
Overcoming the problem resulting from the fact that an eavesdropper may have better channel conditions than a receiver.
Reducing complexity compared to public key cryptography. This is because that the secrecy of the generated key is not dependent on the hardness of a computational problem but relies on the physical characteristics of the wireless channel fading.

In some embodiments of the present application, a method for generating a secret key based on wireless channel measurements may include the following steps:
Step 1: channel probing. In step 1, a transmitter and a receiver may collect channel measurement results such as channel state information (CSI), received signal strength (RSS), phase, etc.
Step 2: randomness extraction. In step 2, the received signals at the transmitter and the receiver may contain deterministic parts that can be determined or inferred by an attacker. For example, the transmitter and the receiver may apply channel measurement results that cannot be determined or inferred by the attacker (e.g., eavesdropper, malicious user, etc.).
Step 3: quantization. In step 3, the transmitter and the receiver may quantize the extracted random channel measurement results into bits.
Step 4: information reconciliation. Step 4 is an error correction step carried out between the transmitter and the receiver in order to ensure that the keys separately generated by the transmitter and the receiver are identical. For instance, parity bit information can be exchanged between the transmitter and the receiver to correct errors, and a certain amount of bit information may be revealed to the attacker.

In the above four steps, step 3 is the most important step. The secret key generation methods should take both the security of the secret key and the performance of the distributed learning aided by the secret key into consideration. For the security of the secret key, it can be characterized by such as the length of the generated secret key or the entropy of the generated secret key. For the performance of the distributed learning aided by the secret key, it can be characterized by such as the convergence speed or the overall accuracy of the distributed learning.

Embodiments of the present application provide solutions for generating a secret key based on wireless channel measurements. For example, embodiments of the present application provide several solutions regarding configurations, signaling, and procedures for quantization in generating the secret key based on wireless channel measurements, which take both the security of the secret key and the performance of the distributed learning aided by the secret key into consideration. More details will be described in the following text in combination with the appended drawings.

According to some embodiments of the present application, a distributed learning scenario may include a BS, a center server (which is either separated from the BS or integrated into the BS), and M distributed nodes (e.g., UEs). In each training epoch, the center server may transmit the model parameters to all distributed nodes involved in the training epoch. Each distributed node may conduct one round of training and upload a gradient value of the model to the BS. Then the BS may transmit the gradient value received from each distributed node to the center server.

Each distributed node and the BS may generate a secret key for transmission of the gradient value of the model from the distributed node to the BS. The granularity (or frequency) of generating the secret key may be per training epoch (e.g., per round of training), per global model generation (e.g., per convergence of the distributed learning), etc. The secret key may be generated based on the following steps:
1) Step (1): channel estimation.
   In step (1), the distributed node may transmit one or more reference signals (also referred to as pilot signals) to the BS. For example, a reference signal may be a sounding reference signal (SRS). In response to receiving the one or more reference signals, the BS may obtain m channel measurement values through m independent channel measurements or estimations. In an embodiment, each channel measurement value may be defined as |ĥ|, wherein ĥ is the channel gain measured or estimated by the BS, which is given by the following formula (1):

$$\hat{h} = \frac{h x + N}{x} = h + \frac{N}{x} \qquad ( 1 )$$

Here h is the actual channel gain, N is the Gaussian white noise, and x is a strength of reference signal transmitted by the distributed node.
In step (1), the BS may transmit one or more reference signals to the distributed node. For example, a reference signal may be a channel state information reference signal (CSI-RS). In response to receiving the one or more reference signals, the distributed node may obtain m channel measurement values through m independent channel measurements or estimations. The number of channel measurements or estimations performed by the distributed noted may be the same as or different from the number of channel measurements or estimations performed by the BS. In an embodiment, each channel measurement value may be defended as |ĥ|, wherein ĥ is the channel gain measured or estimated by the distributed node, which is also given by the above formal (1), except that x is a strength of reference signal transmitted by the BS. Assuming uplink/downlink channel reciprocity holds, the measured channel gain at the distributed node can be approximated to the measured channel gain at the BS such that the distributed node and the BS can acquire the same secret key based on their individual channel measurements.
2) Step (2): generating a secret key by means of quantization.
   In step (2), each of the BS and the distributed node may map one or more channel measurement values into n bits through quantization as well as other processing rules. Thus, each of the BS and the distributed node may obtain a secret key with a length of n bits. For example, the secret key may be denoted by c₁ c₂ . . . cₙ, wherein cᵢ=0 or 1, 1≤i≤n.

Then, the distributed node may encrypt the gradient value of the model using the secret key generated at the distributed node, and the BS may decrypt the encrypted gradient value using the secret key generated at the BS.

For example, in the encryption process, the distributed node may transform the gradient value to the encrypted gradient value based on the following formula (2):

$${\tilde{d}}_{i} = {d}_{i} ( 2 {c}_{j} - 1 ) , where j = i mod n \qquad ( 2 )$$

Here \tilde{d}ᵢ is the ith bit of the encrypted gradient value, dᵢ is the ith bit of the gradient value, wherein 1≤i≤N and N is the number of bits included in the gradient value, and cⱼ is the jth bit of the secret key generated at the distributed node as stated above.

According to formula (2), the encryption process applies each bit of the secret key sequentially for each bit of the gradient value. When a bit of the secret key is one, it does not change the bit of the gradient value for which the bit of the secret key is applied. When a bit of the secret key is zero, it changes the sign of the bit of the gradient value for which the bit of the secret key is applied. Thus, without the knowledge of the secret key, the gradient value may be completely reversed. Therefore, the security of the secret key is required, and thus the encrypted gradient value can be transmitted securely.

In the decryption process, the BS may transform the encrypted gradient value to the decrypted gradient value based on the following formula (3):

$${\hat{d}}_{i} = {\tilde{d}}_{i} ( 2 {c}_{j} - 1 ) , where j = i mod n . \qquad ( 3 )$$

Here \hat{d}ᵢ is the ith bit of the decrypted gradient value, \tilde{d}ᵢ is the ith bit of the encrypted gradient value, wherein 1≤i≤N and N is the number of bits included in the gradient value, and cⱼ is the jth bit of the secret key generated at the BS as stated above. Then, the BS may transmit the decrypted gradient value to the center server such that the center server may use the decrypted gradient value from each distributed node to learn a global statistical model.

The following embodiments may provide several methods for generating the secret key based on wireless channel measurements.

FIG. 2 illustrates a flowchart of an exemplary method 200 for generating a secret key according to some embodiments of the present application. The method 200 illustrated in FIG. 2 may be performed by a UE (e.g., UE 101a or UE 101b in FIG. 1). The UE may also be referred to as a remote device or a distributed node in some embodiments of the present application.

As shown in FIG. 2, in step 201, the UE may obtain first configuration information for generating a secret key. For example, the UE may obtain the first configuration information based on configuration, pre-configuration, or pre-definition.

In some embodiments of the present application, the UE may obtain the first configuration information based on configuration. Specifically, obtaining the first configuration information based on configuration (i.e., the first configuration information is configured to the UE) may refer to that: the first configuration information is transmitted by a BS (e.g., BS 102 as shown in FIG. 1) to the UE via at least one of: a SIB message, a MIB message, an RRC signaling, or a MAC CE, or DCI, such that the UE may receive the first configuration information from the BS. In an embodiment of the present application, obtaining the first configuration information based on configuration may apply to the scenario where the UE is in coverage of a network.

In some other embodiments of the present application, the UE may obtain the first configuration information based on pre-configuration or pre-definition. Specifically, obtaining the first configuration information based on pre-configuration or pre-definition (i.e., the first configuration information is pre-configured or pre-defined to the UE) may refer to that: the first configuration information may be hard-wired into the UE or stored on a subscriber identity module (SIM) or universal subscriber identity module (USIM) card for the UE, such that the UE may obtain the first configuration information within the UE. In an embodiment of the present application, obtaining the first configuration information based on pre-configuration or pre-definition may apply to the scenario where the UE is out of coverage of the network.

The first configuration information may indicate a quantization scheme, which is used to quantize one or more channel measurement values. In some embodiments, the quantization scheme may be a comparison-based quantization scheme, a threshold-based quantization scheme, a hybrid quantization scheme, a selection-based quantization scheme, or any other quantization schemes in existing technologies. The comparison-based quantization scheme, threshold-based quantization scheme, hybrid quantization scheme, and selection-based quantization scheme will be described in detail later. In some embodiments, the first configuration information may explicitly indicate the quantization scheme. For example, each quantization scheme may have a corresponding index, and the first configuration information may include an indicator indicating an index corresponding to a quantization scheme. In some embodiments, the first configuration information may implicitly indicate the quantization scheme. For example, the quantization scheme may be indicated by at least one parameter (e.g., the number of channel measurements for generating a secret key, index(es) of channel measurements for generating a secret key, etc.) indicated by the first configuration information, which will be described in detail later.

In some embodiments, the UE may obtain multiple quantization schemes based on configuration, pre-configuration, or pre-definition. The first configuration information may indicate one of the multiple quantization schemes. All the definitions regarding configuration, pre-configuration, or pre-definition as described in the above embodiments may also apply here.

According to some embodiments of the present application, the first configuration information may indicate a length of the secret key.

According to some embodiments of the present application, the UE may obtain second configuration information indicating a set of quantization intervals. For example, the UE may obtain the second configuration information based on configuration, pre-configuration, or pre-definition. All the definitions regarding configuration, pre-configuration, or pre-definition as described in the above embodiments may also apply here. A channel measurement value falling within a quantization interval may be quantized to a code word corresponding to the quantization interval.

In some embodiments, the second configuration information may indicate a set of endpoints (also referred to as boundaries or borders) defining the set of quantization intervals. Then, based on the set of endpoints, the UE may determine the set of quantization intervals.

In some embodiments, the second configuration information may indicate an index of an entry in a lookup table, and the entry corresponds to the set of quantization intervals. In such embodiments, the UE may obtain the lookup table based on configuration, pre-configuration, or pre-definition. The lookup table may include at least one entry, wherein each entry may be associated with an index and corresponds to a set of quantization intervals (e.g., defined by a set of endpoints). Then, based on the index indicated by the second configuration information, the UE may determine a corresponding set of quantization intervals from the lookup table.

In some embodiments, the second configuration information may further indicate mapping relationship between the set of quantization intervals and a set of code words. For example, each quantization interval of the set of quantization intervals may map to (or correspond to or be associated with) a code word of the set of code word. In an embodiment, the number of quantization intervals included in the set of quantization intervals is associated with the length of each code word. For example, each code word may have n bits in the case of 2ⁿ quantization intervals.

In the case that the mapping relationship is not explicitly indicated, the UE may determine the mapping relationship by default. For example, when the second configuration information indicates four quantization intervals, the UE may determine by default that the first quantization interval corresponds to “00,” the second quantization interval corresponds to “01,” the third quantization interval corresponds to “10,” and the fourth quantization interval corresponds to “11.”

The set of quantization intervals indicated by the second configuration information may follow a quantization interval design scheme. The following embodiments provide two exemplary quantization interval design schemes for defining the set of quantization intervals. The set of quantization intervals may be used for the comparison-based quantization scheme, the threshold-based quantization scheme, the hybrid quantization scheme, the selection-based quantization scheme, or any other quantization schemes in existing technologies.

### Embodiment 1

Embodiment 1 provides a channel-related quantization interval design scheme. In other words, the set of quantization intervals depend on a channel model.

In embodiment 1, the set of quantization intervals is divided such that channel measurement values (or measured channel gains) fall within each quantization interval with equal probabilities. In other words, the code words for a secret key are uniformly distributed in all quantization intervals, which maximizes the entropy of the secret key.

For example, for an n-bit secret key, there are 2ⁿ code words and corresponding 2ⁿ quantization intervals. Let F(h) denote a distribution function of a channel gain |h|. Then, the ith quantization interval [tᵢ₋₁, tᵢ) may be determined based on the following formulas:

$${t}_{i - 1} = {F}^{- 1} ( \frac{i - 1}{{2}^{n}} ) \qquad ( 4 - 1 )$$

$${t}_{i} = {F}^{- 1} ( \frac{i}{{2}^{n}} ) \qquad ( 4 - 2 )$$

Here, 1≤i≤2ⁿ, t₀=0, and t₂ⁿ=+∞. With this quantization intervals, the channel gain |h| falls within each quantization interval with a probability of 1/2ⁿ. The entropy of a secret key is n bits.

As an example, the channel may be a Rayleigh fading channel, and thus the channel gain follows a Rayleigh distribution, whose distribution function is given by the following formula:

$$F ( h ) = 1 - {e}^{- \frac{{h}^{2}}{2 {σ}^{2}}} \qquad ( 5 )$$

The inverse function of F(h) is given by the following formula:

$${F}^{- 1} ( y ) = \sqrt{- 2 {σ}^{2} ln ( 1 - y )} \qquad ( 6 )$$

Based on the above formulas (4-1), (4-2), (5), and (6), a set of quantization intervals for an n-bit secret key may be determined.

As another example, the channel may be a Rician fading channel, and thus the channel gain follows a Rician distribution. In such example, the quantization intervals for the Rician fading channel may be derived through numerical results. The quantization intervals for the Rician fading channel are different from those for a Rayleigh fading channel.

In some embodiments, to use the channel-related quantization interval design scheme, the channel model and the distribution function of the channel gain may be firstly determined, and then the quantization intervals may be determined based on formulas (4-1) and (4-2).

### Embodiment 2

Embodiment 2 provides a uniform quantization interval design scheme. The quantization intervals determined based on such design scheme may be independent of the channel models.

In embodiment 2, all quantization intervals in the set of quantization intervals have equal lengths except for the last quantization interval in the set of quantization intervals. Such design scheme makes the mismatch probabilities of all code words in the quantization intervals substantively the same.

For example, let the last quantization interval be:

$$[ x , + ∞ ) \qquad ( 7 )$$

Here, x may be determined based on a general channel model or based on empirical experience that the channel gain |h| should be less than x in most of the time.

For example, x may be determined based on the following formula:

$$x = {F}^{- 1} ( 1 - \frac{1}{{2}^{n}} ) + ϵ \qquad ( 8 )$$

Here F(h) may be the estimated distribution function of a channel gain while the channel gain falls in the last quantization interval with a probability less than 1/2ⁿ, and ϵ is a positive real number.

For the other 2ⁿ−1 quantization intervals, the ith quantization interval [tᵢ₋₁, tᵢ) is given by the following formulas:

$${t}_{i - 1} = \frac{i - 1}{{2}^{n} - 1} x \qquad ( 9 - 1 )$$

$${t}_{i} = \frac{i}{{2}^{n} - 1} x \qquad ( 9 - 2 )$$

Based on the uniform quantization interval design scheme, the quantization intervals do not depend on the channel model. Thus, the quantization interval design scheme is easier to be implemented. Moreover, the quantization intervals determined based on the uniform quantization interval design scheme may be longer than that in the channel-related quantization interval design scheme, which makes the secret key less vulnerable to mismatch. However, since the probability that a code word for a secret key fall in each quantization interval is not equal to each other, the entropy of the generated secret key is reduced to be less than n bits, which may degrade the security of the secret key compared to the channel-related quantization interval design scheme.

As shown in FIG. 2, in step 203, the UE may generate the secret key based on the first configuration information. In some embodiments of the present application, it is assumed that the UE may perform m channel measurements. After each channel measurement, the UE may obtain a channel measurement value. That is, each channel measurement may correspond to or be associated with a channel measurement value. Accordingly, the UE may obtain m channel measurement values through m channel measurements. Each channel measurement may be associated with an index.

In some embodiments of the present application, the first configuration information may indicate a comparison-based quantization scheme. For example, the first configuration information may explicitly indicate the comparison-based quantization scheme. Alternatively or additionally, the first configuration information may implicitly indicate the comparison-based quantization scheme by indicating a number of channel measurement values used for generating the secret key.

In an embodiment of the present application, the first configuration information may indicate that a single channel measurement value is used for generating the secret key. For example, the first configuration information may include an indicator indicating the number of channel measurement values used for generating the secret key to be 1.

After obtaining the first configuration information indicating that a single channel measurement value is used for generating the secret key, to reduce the secret key mismatch probability, the UE may determine a single channel measurement value which has a maximum distance relative to a closer endpoint of a quantization interval within which the single channel measurement value falls (or where the single channel measurement value locates). In other words, the UE may determine a single channel measurement value which has a maximum distance relative to the closest endpoint among all endpoints defining the set of quantization intervals.

Then, the UE may determine the secret key based on a code word corresponding to the quantization interval within which the single channel measurement value falls. For example, the UE may determine the secret key to be a code word corresponding to the quantization interval within which the single channel measurement value falls.

For example, for an n-bit secret key, there are 2ⁿ different code words for the secret key and 2ⁿ quantization intervals. The ith quantization interval is denoted by [tᵢ₋₁, tᵢ) for i∈{1, . . . , 2ⁿ}. The endpoints of the ith quantization interval are tᵢ₋₁ and tᵢ. As stated above, the 2ⁿ quantization intervals may be indicated by the second configuration information. Each of the 2ⁿ quantization intervals may correspond to a code word of the 2ⁿ different code words.

In an embodiment, the UE may determine the single channel measurement value (e.g., corresponding to a channel measurement with an index denoted as I_{choose}) based on the following formula:

$${I}_{choose} = {arg max}_{j ∈ \{ 1 , … , m \}} \{ min \{ \vert {\hat{h}}_{j} \vert - {t}_{i - 1} , {t}_{i} - \vert {\hat{h}}_{j} \vert \} {𝕀}_{{t}_{i - 1} \leq \vert {\hat{h}}_{j} \vert < {t}_{i}} \} \qquad ( 10 )$$

In formula (10), |ĥⱼ| is the channel measurement value corresponding to the jth channel measurement for j∈{1, . . . , m}, m is a number of channel measurement values obtained by the UE, and [symbol] _{t-1≤|h}_{ₕ}^{|<t}ᵢ refers to that falls within the quantization interval [tᵢ₋₁, tᵢ).

After determining I_{choose}, the UE may determine a quantization interval within which the channel measurement value corresponding the channel measurement with the index of I_{choose} falls, and further determine the secret key based on (e.g., to be) a code word corresponding to the determined quantization interval.

In an embodiment of the present application, the first configuration information may indicate that m1 (1≤m1≤m) channel measurement values are used for generating the secret key. For example, the first configuration information may include an indicator indicating the number of channel measurement values used for generating the secret key to be m1.

After obtaining the first configuration information indicating that m1 channel measurement value are used for generating the secret key, to reduce the secret key mismatch probability, the UE may determine m1 channel measurement values from m channel measurement values obtained by the UE through m channel measurements, wherein the m1 channel measurement values have the greatest m1 distances, each of which is relative to a closer endpoint of a quantization interval within which a channel measurement value of the m1 channel measurement values falls.

For example, for each channel measurement value |ĥⱼ| (wherein j∈{1, . . . , m}), the UE may determine a distance (e.g., denoted as dⱼ) based on the following formula:

$${d}_{j} = min \{ \vert {\hat{h}}_{j} \vert - {t}_{i - 1} , {t}_{i} - \vert {\hat{h}}_{j} \vert \} {𝕀}_{{t}_{i - 1} \leq \vert {\hat{h}}_{j} \vert < {t}_{i}} \qquad ( 11 )$$

Then, the UE may determine the greatest m1 dⱼ and corresponding m1 channel measurement values from the m channel measurement values obtained by the UE.

Then, the UE may determine the secret key based on m1 code words, wherein each of the m1 code words corresponds to a quantization interval within which a channel measurement value of the m1 channel measurement values falls. For example, the UE may determine the secret key to include the m1 code words, e.g., the secret key is a concatenation of the m1 code words.

In some embodiments of the present application, the first configuration information may indicate a threshold-based quantization scheme. For example, the first configuration information may explicitly indicate the threshold-based quantization scheme. Alternatively or additionally, the first configuration information may implicitly indicate the threshold-based quantization scheme by indicating one or more ratio values, and each ratio value is associated with at least one quantization interval.

After obtaining the first configuration information indicating the one or more ratio values, the UE may determine, for each channel measurement value, whether a distance from the channel measurement value to a closer endpoint of a quantization interval within which the channel measurement value falls is greater than a length of the quantization interval multiplying an associated radio value indicated by the first configuration information.

For example, for each channel measurement value (e.g., denoted as |ĥⱼ|, wherein j∈{1, . . . , m}), the UE may determine whether the following formula is satisfied:

$$min \{ \vert {\hat{h}}_{j} \vert - {t}_{i - 1} , {t}_{i} - \vert {\hat{h}}_{j} \vert \} > {α}_{i} ( {t}_{i} - {t}_{i - 1} ) \qquad ( 12 )$$

In formula (12), tᵢ₋₁ and tᵢ are endpoints of a quantization interval within which the channel measurement value |ĥⱼ| falls (i.e., the ith quantization interval [tᵢ₋₁, tᵢ)), and αᵢ is the ratio value associated with the quantization interval [tᵢ₋₁, tᵢ) as indicated by the first configuration information.

Then, the UE may determine m2 channel measurement values from the m channel measurement values obtained by the UE, wherein the m2 channel measurement values are all the channel measurement values that satisfy formula (12).

Then, the UE may determine the secret key based on m2 code words, wherein each of the m2 code words corresponds to a quantization interval within which a channel measurement value of the m2 channel measurement values falls. For example, the UE may determine the secret key to include the m2 code words, e.g., the secret key is a concatenation of the m2 code words.

In some embodiments of the present application, the first configuration information may indicate a hybrid quantization scheme, which is a hybrid of the comparison-based quantization scheme and the threshold-based quantization scheme. For example, the first configuration information may explicitly indicate the hybrid quantization scheme. Alternatively or additionally, the first configuration information may implicitly indicate the hybrid quantization scheme by indicating both the one or more ratio values as stated above and the number of channel measurement values (e.g., denoted by m1) used for generating the secret key, wherein 1≤m1≤m, and m is a number of channel measurement values obtained by the UE.

After obtaining the first configuration information indicating both the one or more ratio values and the number of channel measurement values used for generating the secret key, the UE may first determine m2 channel measurement values satisfying formula (12) as stated above. Then, the UE may determine m1 channel measurement values from the m2 channel measurement values, wherein the m1 channel measurement values have the greatest m1 distances, each of which is relative to a closer endpoint of a quantization interval within which a channel measurement value of the m1 channel measurement values falls.

Then, the UE may determine the secret key based on m1 code words, wherein each of the m1 code words corresponds to a quantization interval within which a channel measurement value of the m1 channel measurement values falls. For example, the UE may determine the secret key to include the m1 code words, e.g., the secret key is a concatenation of the m1 code words.

In some embodiments of the present application, the first configuration information may indicate a selection-based quantization scheme. For example, the first configuration information may explicitly indicate the selection-based quantization scheme. Alternatively or additionally, the first configuration information may implicitly indicate the selection-based quantization scheme by indicating index(es) of one or more channel measurements whose channel measurement values are used for generating the secret key.

After obtaining the first configuration information indicating index(es) of one or more channel measurements, the UE may determine the secret key based on one or more code words, wherein each of the one or more code words corresponds to a quantization interval within which a channel measurement value of a channel measurement of the one or more channel measurements falls.

As an example, the first configuration information may indicate an index of a channel measurement whose channel measurement value is used for generating the secret key. Then, the UE may determine a quantization interval within which the channel measurement value of the indicated channel measurement falls, and further determine the secret key based on (e.g., to be) a code word corresponding to the quantization interval.

As another example, the first configuration information may indicate indexes of at least two channel measurements whose channel measurement values are used for generating the secret key. Then, the UE may determine the secret key based on at least two code words, wherein each of the at least two code words corresponds to a quantization interval in which a channel measurement value of a channel measurement of the at least two channel measurements falls. For example, the UE may determine the secret key to include the at least two code words, e.g., the secret key is a concatenation of the at least two code words.

After generating the secret key, the UE may encrypt the gradient value of a model generated by the UE using the secret key. For example, the UE may encrypt the gradient value based on formula (2). Then, the UE may transmit the encrypted gradient value to the BS.

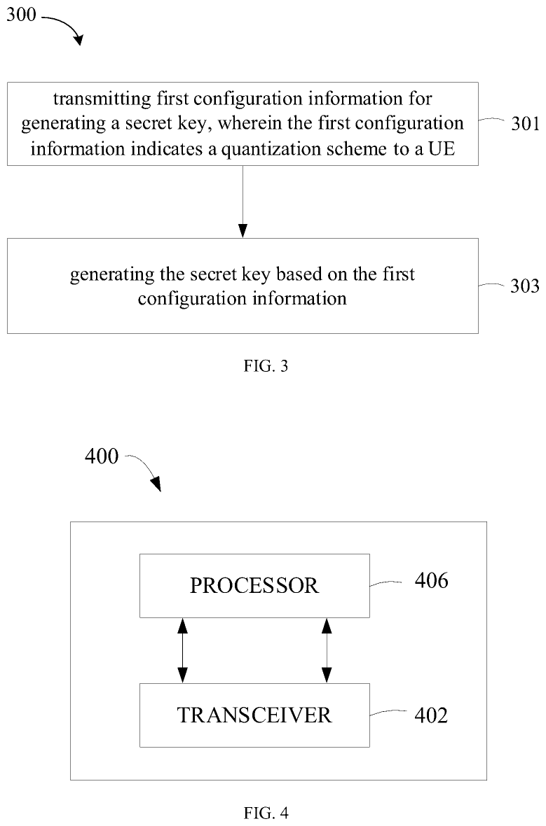

FIG. 3 illustrates a flowchart of an exemplary method 300 for generating a secret key according to some other embodiments of the present application. The method 300 illustrated in FIG. 3 may be performed by a BS (e.g., BS 102 in FIG. 1).

As shown in FIG. 3, in step 301, the BS may transmit first configuration information for generating a secret key to a UE (e.g., UE 101a or UE 101b in FIG. 1).

In some embodiments of the present application, the BS may transmit the first configuration information via at least one of: a MIB message, a SIB message, an RRC signaling, a MAC CE, or DCI.

The first configuration information may indicate a quantization scheme, which is used to quantize one or more channel measurement values. In some embodiments, the quantization scheme may be a comparison-based quantization scheme, a threshold-based quantization scheme, a hybrid quantization scheme, a selection-based quantization scheme, or any other quantization schemes in existing technologies. All the definitions and designs regarding the comparison-based quantization scheme, the threshold-based quantization scheme, the hybrid quantization scheme and the selection-based quantization scheme as described in the above embodiments may also apply here.

In some embodiments, the first configuration information may explicitly indicate the quantization scheme. For example, each quantization scheme may have a corresponding index, and the first configuration information may include an indicator indicating an index corresponding to a quantization scheme. In some embodiments, the first configuration information may implicitly indicate the quantization scheme. For example, the quantization scheme may be indicated by at least one parameter (e.g., the number of channel measurements for generating a secret key, index(es) of channel measurements for generating a secret key, etc.) included in the first configuration information, as described in the above embodiments.

In some embodiments, the BS may configure multiple quantization schemes to the UE, e.g., via an RRC signaling. The first configuration information may indicate (or activate) one of the multiple quantization schemes. In such embodiments, the first configuration information may be transmitted via a MAC CE or DCI.

In some embodiments, the BS may determine a quantization scheme and transmit the first configuration information indicating the determined quantization scheme to the UE. For example, the quantization scheme may be determined based on the radio propagation environment, which is up to the BS's implementation. As an example, if a channel is with rich scattering, it may cause a lot of fading and multi-path reflections. That is, there are much more channel randomness, and thus more independent channel measurement values can be obtained. In such example, the BS may determine the threshold-based quantization scheme. As another example, if a channel is with relatively poor scattering, then the BS may determine the comparison-based quantization scheme.

According to some embodiments of the present application, the first configuration information may indicate a length of the secret key. In some embodiments, the length of the secret key may be determined by the BS based on at least one of the followings: a channel state between the BS and the UE, the processing capability of the UE, the security level, etc., which is up to the BS's implementation.

According to some embodiments of the present application, the BS may transmit second configuration information indicating a set of quantization intervals. In some embodiments of the present application, the BS may transmit the second configuration information via at least one of: a MIB message, a SIB message, an RRC signaling, a MAC CE, or DCI. All the definitions and designs regarding the second configuration information as described in the above embodiments may also apply here.

In some embodiments, the second configuration information may indicate a set of endpoints (also referred to as boundaries or borders) defining the set of quantization intervals.

In some embodiments, the second configuration information may indicate an index of an entry in a lookup table, and the entry corresponds to the set of quantization intervals. In such embodiments, the BS may transmit the lookup table to the UE, e.g., via RRC signaling.

In some embodiments, the second configuration information may further indicate mapping relationship between the set of quantization intervals and a set of code words. For example, each quantization interval of the set of quantization intervals may map to (or correspond to or be associated with) a code word of the set of code word.

All the definitions and designs regarding the quantization interval design schemes for defining the set of quantization intervals as described in the above embodiments may also apply here. As an example, a channel-related quantization interval design scheme (e.g., embodiment 1) is applied, in which the set of quantization intervals is divided such that channel measurement values fall within each quantization interval with equal probabilities. As another example, a uniform quantization interval design scheme (e.g., embodiment 2) is applied, in which all quantization intervals in the set of quantization intervals have equal lengths except for the last quantization interval in the set of quantization intervals.

In some embodiments, the BS may determine the set of quantization intervals based on the radio propagation environment, which is up to the BS's implementation. As an example, if the environment is highly dynamic, then the channel model may change fast. The distribution of the channel gain may vary over time. In such example, the uniform quantization interval design scheme may be selected. As another example, if the environment remains stable, then the accurate channel model can be obtained. The selection of quantization intervals depends on the distribution of channel gain. If the distribution of channel gain is relatively flattened, then the channel-related quantization interval design scheme may be selected since it can achieve higher entropy of the secret key with low key mismatch probability. Otherwise, the uniform quantization interval design scheme may be selected to address the problems caused by the highly dynamic channel.

As shown in FIG. 3, in step 303, the BS may generate the secret key based on the first configuration information. It is contemplated that the operations of the BS may be similar to those of the UE which are described with respect to step 203 in FIG. 2. All the definitions and operations related to the first configuration information and the quantization schemes described in the above embodiments of FIG. 2 may also apply here.

In some embodiments of the present application, the BS may perform m channel measurements. The number of channel measurements performed by the BS may be the same as the number of channel measurements performed by the UE. After each channel measurement, the BS may obtain a channel measurement value. That is, each channel measurement may correspond to or be associated with a channel measurement value. Accordingly, the BS may obtain m channel measurement values through m channel measurements. Each channel measurement may be associated with an index.

In some embodiments of the present application, the BS may use the comparison-based quantization scheme to determine the secret key.

In an embodiment of the present application, the first configuration information may indicate that a single channel measurement value is used for generating the secret key.

In such embodiment, the BS may determine a single channel measurement value which has a maximum distance relative to a closer endpoint of a quantization interval within which the single channel measurement value falls. Then, the BS may determine the secret key based on a code word corresponding to the quantization interval within which the single channel measurement value falls. For example, the BS may determine the secret key to be a code word corresponding to the quantization interval within which the single channel measurement value falls.

In an embodiment of the present application, the first configuration information may indicate that m1 channel measurement values are used for generating the secret key, wherein 1≤m1≤m, and m is a number of channel measurement values obtained by the UE.

In such embodiment, the BS may determine m1 channel measurement values from m channel measurement values obtained by the BS, wherein the m1 channel measurement values have the greatest m1 distances, each of which is relative to a closer endpoint of a quantization interval within which a channel measurement value of the m1 channel measurement values falls.

Then, the BS may determine the secret key based on m1 code words, wherein each of the m1 code words corresponds to a quantization interval within which a channel measurement value of the m1 channel measurement values falls. For example, the BS may determine the secret key to include the m1 code words, e.g., the secret key is a concatenation of the m1 code words.

In some embodiments of the present application, the BS may determine to use the threshold-based quantization scheme to determine the secret key. In such embodiments, the first configuration information may indicate one or more ratio values, and each ratio value is associated with at least one quantization interval.

In such embodiments, the BS may determine m2 channel measurement values from a set of channel measurement values obtained by the BS, wherein a distance from each channel measurement value of the m2 channel measurement values to a closer endpoint of a quantization interval within which the channel measurement value falls is greater than a length of the quantization interval multiplying an associated radio value indicated by the first configuration information.

Then, the BS may determine the secret key based on m2 code words, wherein each of the m2 code words corresponds to a quantization interval within which a channel measurement value of the m2 channel measurement values falls. For example, the UE may determine the secret key to include the m2 code words, e.g., the secret key is a concatenation of the m2 code words.

In some embodiments of the present application, the BS may determine to use the hybrid quantization scheme to generating the secret key. In such embodiments, in addition to the one or more ratio values as stated above, the first configuration information may also indicate that m1 channel measurement values are used for generating the secret key, wherein 1m1≤m, and m is a number of channel measurement values obtained by the UE.

In such embodiments, the BS may first determine m2 channel measurement values as stated above. Then, the BS may determine m1 channel measurement values from the m2 channel measurement values, wherein the m1 channel measurement values have the greatest m1 distances, each of which is relative to a closer endpoint of a quantization interval within which a channel measurement value of the m1 channel measurement values falls.

Then, the BS may determine the secret key based on m1 code words, wherein each of the m1 code words corresponds to a quantization interval within which a channel measurement value of the m1 channel measurement values falls. For example, the UE may determine the secret key to include the m1 code words, e.g., the secret key is a concatenation of the m1 code words.

In some embodiments of the present application, the BS may determine to use the selection-based quantization scheme to generate the secret key. In such embodiments, the first configuration information may indicate index(es) of one or more channel measurements whose channel measurement values are used for generating the secret key.

In such embodiments, the BS may determine the secret key based on one or more code words, wherein each of the one or more code words corresponds to a quantization interval within which a channel measurement value of a channel measurement of the one or more channel measurements falls.

As an example, the first configuration information may indicate an index of a channel measurement whose channel measurement value is used for generating the secret key. For example, the indicated channel measurement may correspond to a channel measurement value which has a maximum distance relative to a closer endpoint of a quantization interval within which the channel measurement value falls. In such example, the BS may determine a quantization interval within which the channel measurement value falls, and further determine the secret key based on (e.g., to be) a code word corresponding to the quantization interval.

As another example, the first configuration information may indicate indexes of at least two channel measurements whose channel measurement values are used for generating the secret key. For example, the indicated at least two channel measurements may correspond to the m1 channel measurement values or m2 channel measurement values determined in the above embodiments of FIG. 3. In such example, the BS may determine the secret key based on at least two code words, wherein each of the at least two code words corresponds to a quantization interval in which a channel measurement value of a channel measurement of the at least two channel measurements falls. For example, the BS may determine the secret key to include the at least two code words, e.g., the secret key is a concatenation of the at least two code words.

After generating secret key and receiving the encrypted gradient value from the UE, the BS may decrypt the encrypted gradient value by using the secret key. For example, the BS may decrypt the encrypted gradient value based on formula (3). Then, the BS may transmit the decrypted gradient value to a server (e.g., server 103 in FIG. 1).

FIG. 4 illustrates a simplified block diagram of an exemplary apparatus 400 for generating a secret key according to some embodiments of the present application. In some embodiments, the apparatus 400 may be or include at least part of a UE (e.g., UE 101a or UE 101b in FIG. 1). In some other embodiments, the apparatus 400 may be or include at least part of a BS (e.g., BS 102 in FIG. 1).

Referring to FIG. 4, the apparatus 400 may include at least one transceiver 402 and at least one processor 406. The at least one transceiver 402 is coupled to the at least one processor 406.

Although in this figure, elements such as the transceiver 402 and the processor 406 are illustrated in the singular, the plural is contemplated unless a limitation to the singular is explicitly stated. In some embodiments of the present application, the transceiver 402 may be divided into two devices, such as receiving circuitry (or a receiver) and transmitting circuitry (or a transmitter). In some embodiments of the present application, the apparatus 400 may further include an input device, a memory, and/or other components. The transceiver 402 and the processor 406 may be configured to perform any of the methods described herein (e.g., the methods described with respect to FIGS. 2 and 3 or other methods described in the embodiments of the present application).

According to some embodiments of the present application, the apparatus 400 may be a UE, and the transceiver 402 and the processor 406 may be configured to perform operations in the methods as described with respect to FIG. 2 or other methods described in the embodiments of the present application. For example, the processor 406 is configured to: obtain first configuration information for generating a secret key, wherein the first configuration information indicates a quantization scheme; and generate the secret key based on the first configuration information.

According to some embodiments of the present application, the apparatus 400 may be a BS, and the transceiver 402 and the processor 406 may be configured to perform operations in the methods as described with respect to FIG. 3 or other methods described in the embodiments of the present application. For example, the processor 406 is configured to: transmit, via the transceiver 402, first configuration information for generating a secret key, wherein the first configuration information indicates a quantization scheme to a UE; and generate the secret key based on the first configuration information.

In some embodiments of the present application, the apparatus 400 may further include at least one non-transitory computer-readable medium. In some embodiments of the present disclosure, the non-transitory computer-readable medium may have stored thereon computer-executable instructions to cause the processor 406 to implement any of the methods as described above. For example, the computer-executable instructions, when executed, may cause the processor 406 to interact with the transceiver 402, so as to perform operations of the methods, e.g., as described with respect to FIGS. 2 and 3 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for generating a secret key, including a processor and a memory. Computer programmable instructions for implementing a method for generating a secret key are stored in the memory, and the processor is configured to perform the computer programmable instructions to implement the method for generating a secret key. The method for generating a secret key may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for generating a secret key according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
obtain first configuration information for generating a secret key, wherein the first configuration information indicates a quantization scheme; and
generate the secret key based on the first configuration information.

2. The UE of claim 1, wherein the at least one processor is configured to cause the UE to obtain second configuration information indicating a set of quantization intervals.

3. The UE of claim 2, wherein the second configuration information further indicates mapping relationship between the set of quantization intervals and a set of code words.

4. The UE of claim 2, wherein:
the set of quantization intervals is divided such that channel measurement values fall within each quantization interval with equal probabilities; or
all quantization intervals in the set of quantization intervals have equal lengths except for the last quantization interval in the set of quantization intervals.

5. The UE of claim 1, wherein the first configuration information indicates that a single channel measurement value is used for generating the secret key.

6. The UE of claim 5, wherein the at least one processor is configured to cause the UE to:
determine the single channel measurement value which has a maximum distance relative to a closer endpoint of a quantization interval within which the single channel measurement value falls; and
determine the secret key based on a code word corresponding to the quantization interval within which the single channel measurement value falls.

7. The UE of claim 1, wherein the first configuration information indicates index(es) of one or more channel measurements whose channel measurement values are used for generating the secret key.

8. The UE of claim 7, wherein the at least one processor is configured to cause the UE to:
determine the secret key based on one or more code words, wherein each of the one or more code words corresponds to a quantization interval within which a channel measurement value of a channel measurement of the one or more channel measurements falls.

9. The UE of claim 1, wherein the first configuration information indicates that m1 channel measurement values are used for generating the secret key, wherein 1<m1<m, and m is a number of channel measurement values obtained by the UE.

10. The UE of claim 9, wherein the at least one processor is configured to cause the UE to:
determine m1 channel measurement values from m channel measurement values obtained by the UE, wherein the m1 channel measurement values have the greatest m1 distances,
each of which is relative to a closer endpoint of a quantization interval within which a channel measurement value of the m1 channel measurement values falls; and
determine the secret key based on m1 code words, wherein each of the m1 code words corresponds to a quantization interval within which a channel measurement value of the m1 channel measurement values falls.

11. The UE of claim 1, wherein the first configuration information indicates one or more ratio values, and each ratio value is associated with at least one quantization interval.

12. The UE of claim 11, wherein the at least one processor is configured to cause the UE to:
determine m2 channel measurement values from a set of channel measurement values obtained by the UE, wherein a distance from each channel measurement value of the m2 channel measurement values to a closer endpoint of a quantization interval within which the channel measurement value falls is greater than a length of the quantization interval multiplying an associated radio value indicated by the first configuration information; and
determine the secret key based on m2 code words, wherein each of the m2 code words corresponds to a quantization interval within which a channel measurement value of the m2 channel measurement values falls.

13. The UE of claim 1, wherein the first configuration information indicates a length of the secret key.

14. A base station (BS), comprising:
at least one memory; and
at least one processor coupled with the at least one memory and configured to cause the BS to:
transmit first configuration information for generating a secret key, wherein the first configuration information indicates a quantization scheme to a user equipment (UE); and
generate the secret key based on the first configuration information.

15. The BS of claim 14, wherein the at least one processor is configured to cause the BS to transmit second configuration information indicating a set of quantization intervals.

16. A method performed by a user equipment (UE), comprising:
obtaining first configuration information for generating a secret key, wherein the first configuration information indicates a quantization scheme; and
generating the secret key based on the first configuration information.

17. The method of claim 16, further comprising obtaining second configuration information indicating a set of quantization intervals.

18. The method of claim 16, wherein the second configuration information further indicates mapping relationship between the set of quantization intervals and a set of code words.

19. The method of claim 16, wherein:
the set of quantization intervals is divided such that channel measurement values fall within each quantization interval with equal probabilities; or
all quantization intervals in the set of quantization intervals have equal lengths except for the last quantization interval in the set of quantization intervals.

20. A method performed by a base station (BS), comprising:
transmitting first configuration information for generating a secret key, wherein the first configuration information indicates a quantization scheme to a user equipment (UE); and
generating the secret key based on the first configuration information.
